(19) United States
(12) Patent Application Publication
(10) Pub. No.: US 2026/0336692 A1
(43) Pub. Date: Oct. 29, 2026

(54) Method for Dynamic Adjustment of a Wheel Steering Angle of At Least One Vehicle Wheel of a Vehicle by Changing a Toe of the Vehicle Wheel

(71) Applicant: Robert Bosch GmbH, Stuttgart (DE)

(72) Inventors: Joerg Strecker, Schwaebisch Gmuend (DE); Roland Greul, Schwaebisch Gmuend (DE)

(21) Appl. No.: 19/109,950

(22) PCT Filed: Sep. 12, 2023
(86) PCT No.: PCT/EP2023/075024

§ 371 Date: Mar. 7, 2025

(30) Foreign Application Priority Data
Sep. 15, 2022 (DE) 10 2022 209 671.1

(51) Int. Cl. B62D 6/00

(52) U.S. Cl. CPC B62D 6/002

(57) ABSTRACT

In a method for dynamically adjusting a wheel steering angle of at least one vehicle wheel of a vehicle, which has a steering system with at least one wheel steering angle controller for changing the wheel steering angle of the vehicle wheel and a vehicle sensor system for detecting the driving situation, a toe of the vehicle wheel is dynamically adjusted to a current driving situation in order to adapt the wheel steering angle. An adjustment value dependent on the driving situation is determined as a function of a target value for the toe of the vehicle wheel and a mechanical toe change of the vehicle wheel correlated with the current driving situation, and the wheel steering angle controller for dynamically adjusting the toe of the vehicle wheel is actuated using the adjustment value such that the toe of the vehicle wheel is set to the target value.

### PRIOR ART

The invention proceeds from a method for dynamically adjusting a wheel steering angle of at least one vehicle wheel of a vehicle according to the preamble of claim 1. The invention also relates to a computing unit for performing such a method and a vehicle comprising such a computing unit.

For vehicles and in particular their chassis, manufacturer or vehicle-specific specifications must always be taken into account with regard to kinematic and elastokinematic properties, wherein general comfort and safety aspects also play a role in addition to the basic design. In this context, wheel-specific mechanical toe-in changes are being developed for many scenarios, such as for braking, cornering, driving over obstacles on one side and/or with regard to loading the vehicle. An appropriately designed steering system makes it possible to fulfill these toe change specifications independently of the mechanical design of the vehicle or chassis.

Furthermore, DE 10 2017 221 379 A1 discloses a method for operating a vehicle, wherein the vehicle comprises a steering system with at least one wheel steering angle controller for changing a wheel steering angle of the vehicle wheel, and wherein a toe-in of the vehicle wheel is dynamically adjusted to a current driving situation.

The task of the invention is, in particular, to provide a method for dynamically adjusting a wheel steering angle of at least one vehicle wheel of a vehicle with improved properties with regard to adaptivity and/or variability. The problem is solved by the features of claims 1, 8, and 9, while advantageous embodiments and further embodiments of the invention can be taken from the subclaims.

### DISCLOSURE OF THE INVENTION

The invention is based on a method, in particular a computer-implemented method, for dynamically adjusting a wheel steering angle of at least one vehicle wheel of a vehicle, in particular by changing a toe, advantageously a toe-in, of the vehicle wheel, wherein the vehicle comprises a steering system with at least one wheel steering angle controller for changing the wheel steering angle of the vehicle wheel and a vehicle sensor system for detecting the driving situation, and wherein the toe of the vehicle wheel is dynamically adjusted to a current driving situation in order to adapt the wheel steering angle.

The invention proposes that an adjustment value dependent on the driving situation is determined as a function of a target value for the toe of the vehicle wheel and a mechanical toe change of the vehicle wheel correlated with the current driving situation, and that the wheel steering angle controller for dynamically adjusting the toe of the vehicle wheel is actuated using the adjustment value such that the toe of the vehicle wheel is set to the target value. The target value for the toe of the vehicle wheel and/or the mechanical toe change of the vehicle wheel correlated with the current driving situation can preferably be determined in advance, for example calculated, measured or retrieved from a vehicle operating memory. The mechanical toe change may result in particular from a change in a vehicle height, in particular by changing the spring compression travel at the vehicle wheel, and/or an external force acting on the vehicle wheel and/or the wheel steering angle controller. In the present case, the wheel steering angle controller is therefore actuated to dynamically adjust the toe of the vehicle wheel such that the toe of the vehicle wheel is set or corrected to the target value, taking into account the mechanical toe change. To do this, the adjustment value, i.e. an additional value, is determined in advance to control the wheel steering angle controller, which, in combination with the mechanical toe change, leads to the target value for the toe of the vehicle wheel for the respective driving situation. In this case, the mechanical toe change is set or corrected to the correct target value by a software function if there is a deviation between the target value and the mechanical toe change for the respective driving situation. In particular, this embodiment can be used to improve adaptivity and/or variability and to fulfill toe change specifications and/or toe change requests independently of the mechanical design of the vehicle or the chassis. In addition, an advantageous adjustment of the toe of the vehicle wheel can be achieved in every driving situation.

Preferably, the vehicle is designed as a motor vehicle and comprises, in particular, the steering system and the vehicle sensor system, which is designed to provide at least one sensor variable correlated to a current driving situation. For this purpose, the vehicle sensor system can comprise at least one, in particular electrical, magnetic and/or optical, sensor element. Alternatively or additionally, the vehicle sensor system can determine the sensor variable correlated with the current driving situation based on a sensor model, based on a manipulated variable and/or based on information from at least one other actuator. Furthermore, the steering system is preferably designed as a steer-by-wire steering system, in which a steering input, in particular from a driver, is advantageously transmitted purely electrically to the vehicle wheels. In this case, the steering system comprises at least one wheel steering angle controller and, advantageously, an operating unit that is mechanically separate from the wheel steering angle controller. The term “operating unit” is in this context understood to mean, in particular, an input unit that can be operated by a driver in order to control the at least one wheel steering angle controller. In particular, the operating unit can comprise a steering handle, e.g., in the form of a steering wheel, and advantageously a feedback actuator, e.g., in the form of an electric motor used for generating a steering resistance and/or a restoring torque to the steering handle. The term “wheel steering angle controller” refers in particular to an actuator unit that is operatively connected to at least one vehicle wheel and is designed to transmit a steering input to the vehicle wheel by changing the steering angle of at least one vehicle wheel, thereby favorably controlling at least one alignment of the vehicle wheel and/or influencing a direction of travel of the vehicle. To this end, the wheel steering angle controller advantageously comprises at least one steering regulator element, for example in the form of a gear rack, and at least one steering actuator, for example in the form of an electric motor, which is operatively connected to the steering regulator element. In this case, the wheel steering angle controller can in particular be associated with a front axle or a rear axle of the vehicle. In addition, the vehicle may have further components and/or assemblies, such as at least one spring-damper unit, in particular associated with the vehicle wheel, for absorbing a force acting on the vehicle wheel from the underground.

The vehicle also comprises at least one computing unit which is designed to carry out the procedure for dynamically adjusting the wheel steering angle of the at least one vehicle wheel. The term “computing unit” is mainly understood to mean an electrical and/or electronic unit having an information input, information processing, and an information output. Advantageously, the computing unit also has at least one processor, at least one operating memory, at least one input means and/or output means, at least one operating program, at least one control routine, at least one calculation routine, at least one determination routine, at least one evaluation routine and/or at least one adaptation routine. In particular, the computing unit is designed to determine the adjustment value dependent on the driving situation, depending on the target value for the toe of the vehicle wheel and the mechanical toe change correlated with the current driving situation. In addition, the computing unit can be used to determine the target value and the mechanical toe change of the vehicle wheel. The computing unit can also be used to control the wheel steering angle controller. In this context, the computing unit is particularly designed to control the wheel steering angle controller for dynamically adjusting the toe of the vehicle wheel using the adjustment value such that the toe of the vehicle wheel is set to the target value. Preferably, the computing unit is integrated into a control device of the vehicle, for example a central vehicle control device, or a control device of the steering system, in particular in the form of a steering control device. The term “provided” is understood in particular as meaning specifically programmed, designed and/or equipped. In particular, the phrase “an object being provided for a specific function” is intended to mean that the object fulfills and/or performs this specific function in at least one application state and/or operating state.

The target value is also determined as a function of a steering input, advantageously at the steering handle of the steering system, and as a function of at least one sensor variable of the vehicle sensor system, advantageously of a plurality of sensor variables of the vehicle sensor system. Furthermore, the mechanical toe change is preferably determined as a function of a steering input, advantageously at the steering handle of the steering system, and as a function of at least one sensor variable of the vehicle sensor system, advantageously several sensor variables of the vehicle sensor system. In this case, the target value is preferably purely controlled and without mechanical or electronic or software-technical adjustment to the respective driving situation, while the mechanical toe change is determined specifically for the respective current driving situation. This makes it easy to determine the target value and/or the mechanical toe change.

It is also proposed that a sensor model be used to determine the target value and/or the mechanical toe change. The sensor model can comprise a combination of several sensor elements or sensors and/or a corresponding model, for example of the vehicle axle. This can be used to advantageously determine the target value and/or the mechanical toe change precisely.

If the vehicle sensor system for determining the mechanical toe change comprises at least one driving dynamics sensor, at least one suspension travel sensor, in particular associated with a spring damper unit of the vehicle, and/or at least one force sensor, in particular associated with the wheel steering angle controller, an advantageous driving situation detection can be achieved and the mechanical toe change can be determined particularly easily. The driving dynamics sensor can be used, for example, to measure lateral acceleration, yaw rate, vehicle speed, roll angle and/or longitudinal acceleration of the vehicle.

Furthermore, the steering system can be designed as a steer-by-wire steering system and the wheel steering angle controller as a central controller. In this case, the wheel steering angle controller is assigned to at least two vehicle wheels, in particular steerable wheels. However, it is proposed that the steering system be designed as a steer-by-wire steering system and the wheel steering angle controller as a single-wheel controller. In this case, the steering system can advantageously comprise a plurality of wheel steering angle controllers, wherein each wheel steering angle controller is associated with exactly one, in particular steerable, vehicle wheel. This can enable advantageous toe alignment for each individual wheel, wherein individual events, such as driving over an obstacle on one side, can be detected and taken into account in the dynamic adjustment of the toe of the vehicle wheel.

In a further embodiment, it is proposed that the steering system comprises at least one further wheel steering angle controller designed as a single-wheel controller for changing a wheel steering angle of at least one further vehicle wheel, wherein a separate, wheel-individual adjustment value is determined for each individual wheel and adjusted using the respective wheel steering angle controller. Accordingly, a further adjustment value that is dependent on the driving situation is determined as a function of a further target value for the toe of the further vehicle wheel and a further mechanical toe change, correlated with the current driving situation, of the further vehicle wheel, so that a separate, wheel-individual adjustment value is determined for each individual wheel a separate, wheel-individual adjustment value is determined, wherein the further wheel steering angle controller for dynamically adjusting the toe of the further vehicle wheel is actuated using the further adjustment value such that the toe of the further vehicle wheel is set to the further target value. In addition, the further target value for the toe of the further vehicle wheel and/or the further mechanical toe change of the further vehicle wheel correlated with the current driving situation can be determined in advance, for example, calculated, measured or retrieved from an operating memory of the vehicle. Preferably, the wheel steering angle controller and the further wheel steering angle controller are assigned to the same vehicle axle, i.e. the front axle or the rear axle, of the vehicle. In addition, the further target value and/or the further mechanical toe change is determined as a function of the steering input, advantageously at the steering handle of the steering system, and as a function of at least one further sensor variable of the vehicle sensor system, advantageously several further sensor variables of the vehicle sensor system. In principle, the target value and the further target value and/or the sensor variable and the further sensor variable can also be identical. This can help to further improve the toe alignment for each individual wheel.

The method for dynamically adjusting the steering angle of the at least one vehicle wheel and the vehicle are not limited to the application and embodiment described above. In particular, the method for dynamically adjusting the steering angle of the at least one vehicle wheel and the vehicle for performing a function described herein may have a number of individual elements, components and units that differs from a number stated herein.

### DRAWINGS

Further advantages follow from the description of the drawings below. The drawings show an exemplary embodiment of the invention.

The figures show:

FIGS. 1a-b a vehicle with an exemplary steering system designed as a steer-by-wire steering system in a simplified representation, and

FIG. 2 an exemplary flowchart with main method steps of a method for dynamically adjusting a wheel steering angle of at least one vehicle wheel of the vehicle.

### DESCRIPTION OF THE EXEMPLARY EMBODIMENT

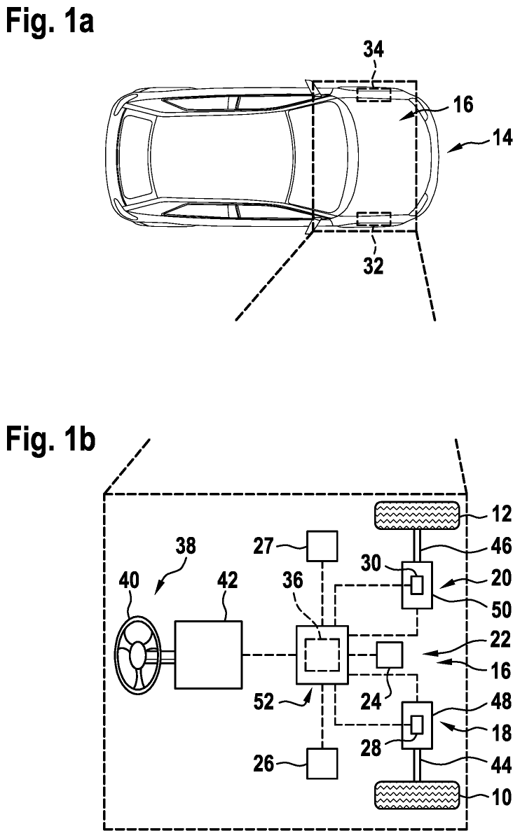

FIGS. 1a and 1b show a simplified illustration of a vehicle 14 which is, e.g., designed as a passenger vehicle comprising a plurality of vehicle wheels 10, 12 and a steering system 16. The steering system 16 is operatively connected to the vehicle wheels 10, 12 and is provided to influence a direction of travel of the vehicle 14. Furthermore, the steering system 16 is designed as a steer-by-wire steering system in the present case, in which a steering input is transmitted electrically to the vehicle wheels 10, 12 in at least one operating state.

The steering system 16 comprises a per se known operating unit 38. The operating unit 38 comprises a steering handle 40, in particular one that can be actuated by a driver, for example in the form of a steering wheel, and a feedback actuator 42, in particular one that is mechanically coupled to the steering handle 40. In the present case, the feedback actuator 42 is at least intended to generate a steering resistance and/or a restoring torque on the steering handle 40. A steering handle could alternatively also be designed as a joystick, a steering lever, and/or as a steering ball or the like. A feedback actuator could in principle also be omitted. It is also conceivable to dispense with an operating unit altogether.

The steering system 16 further comprises at least one wheel steering angle controller 18, 20. As an example, the steering system 16 in the present case comprises two wheel steering angle controllers 18, 20 configured as a single wheel controller and consequently in particular allows steering for each individual wheel. The wheel steering angle controllers 18, 20 are at least essentially identical in design and can be configured in particular as translational and/or rotational controllers. The wheel steering angle controller 18, 20 are designed separately from one another and in the present case are not mechanically connected. The wheel steering angle controllers 18, 20 can be controlled independently of one another. The wheel steering angle controllers 18, 20 are moreover connected to the operating unit 38, and consequently the steering handle 40, in a purely electrical manner. Each of the wheel steering angle controllers 18, 20 has an operative connection to exactly one of the vehicle wheels 10, 12, in particular a front wheel. The wheel steering angle controllers 18, 20 are provided for this purpose to change a respective wheel steering angle of the corresponding vehicle wheel 10, 12 as a function of a steering input. For this purpose, each of the wheel steering angle controllers 18, 20 comprises a steering regulator element 44, 46, designed as an example as a gear rack, and a steering actuator 48, 50 that interacts with the steering regulator element 44, 46 and is designed as an electric motor. Of course, a steering system could in principle also comprise a wheel steering angle controller configured as a central controller. A steering system can furthermore also comprise at least four wheel steering angle controllers designed as single-wheel controllers. A steering system could in principle also comprise a combination of a wheel steering angle controller configured as a single-wheel controller and a wheel steering angle controller configured as a central controller. Moreover, at least one wheel steering angle controller could, in particular, also be assigned to a vehicle wheel that is formed as a rear wheel. Furthermore, a wheel steering angle controller could also be different from a single-wheel controller and/or central controller and, in particular, could be installed in addition to an existing single-wheel controller and/or central controller. In this case, the wheel steering angle controller could be designed as a special additional controller.

Furthermore, the vehicle comprises at least 14 spring-damper units 32, 34. In the present case, the vehicle comprises 14 multiple spring-damper units 32, 34 designed as chassis dampers, wherein, in FIG. 1a, two of the spring-damper units 32, 34 are shown as examples and provided with reference numerals. The spring-damper units 32, 34 are at least essentially of the same design. Each of the spring-damper units 32, 34 is arranged in an area of one of the wheel steering angle controllers 18, 20 and is associated in particular with the respective vehicle wheel 10, 12. In principle, however, a vehicle could also have a different number of spring-damper units.

Furthermore, the vehicle 14 comprises a vehicle sensor system 22, known per se, for detecting the driving situation. The vehicle sensor system 22 is designed to provide at least one sensor variable correlated with a current driving situation. For this purpose, the vehicle sensor system 22 can comprise at least one, in particular electrical, magnetic and/or optical, sensor element. In the present case, the vehicle sensor system 22 comprises, for example, at least one driving dynamics sensor 24, a plurality of suspension travel sensor 26, 27, wherein each of the spring-damper units 32, 34 is associated with one of the suspension travel sensors 26, 27, and a plurality of force sensors 28, 30, wherein one of the force sensors 28, 30 is associated with each of the wheel steering angle controllers 18, 20. The driving dynamics sensor 24 can be used, for example, to measure lateral acceleration, yaw rate, vehicle speed, roll angle and/or longitudinal acceleration of the vehicle 14. The suspension travel sensors 26, 27 can be provided for detecting a change in a vehicle height, in particular by changing a spring compression travel at the corresponding vehicle wheel 10, 12. Furthermore, the force sensors 28, 30 can be provided for detecting an external force acting on the vehicle wheels 10, 12 and/or the wheel steering angle controllers 18, 20, for example in the form of a toe rod force. In addition, the vehicle sensor system 22 can also determine the sensor variable correlated with the current driving situation using a sensor model. In principle, however, it is also conceivable to do without a driving dynamics sensor, suspension travel sensors and/or force sensors altogether. Furthermore, a sensor variable correlated to a current driving situation could also be determined on the basis of a manipulated variable and/or on the basis of information from at least one other actuator.

The vehicle 14 further comprises a control device 52. In the present case, the control device 52 is designed as a steering control device and is therefore part of the steering system 16. The control device 52 also comprises an electrical connection to the operating unit 38. The control device 52 comprises an electrical connection to the wheel steering angle controller 18, 20. In addition, the control device 52 has an electrical connection to the vehicle sensor system 22. The control device 52 is intended to control at least one operation of the steering system 16.

The control device 52 features a computing unit 36. The computing unit 36 comprises at least one processor (not depicted), e.g., in the form of a microprocessor, and at least one operating memory (not depicted). The computing unit 36 also comprises at least one operating program stored in the operating memory and has at least one calculation routine, at least one determination routine, at least one evaluation routine, and/or at least one adaptation routine. A control device could also be different from a steering control device and designed, e.g., as a single, central vehicle control device having a central computing unit. It is also conceivable to provide separate control devices for each wheel steering angle controller and for the operating unit, as well as one operating unit and communicatively interconnect them.

In addition, the vehicle 14 and/or the steering system 16 may comprise further components and/or assemblies not shown, such as, for example, an internal vehicle sensor system for detecting at least one operating signal of the wheel steering angle controller 18, 20, an on-board computer known per se and/or a navigation device known per se.

In general, manufacturer- or vehicle-specific specifications must be taken into account for vehicles and in particular for their chassis with regard to kinematic and elastokinematic properties, wherein general comfort and safety aspects play a role in addition to the basic design. A suitably designed steering system, preferably with individually steered vehicle wheels, makes it possible to fulfill these toe change specifications independently of the mechanical design of the vehicle or the chassis.

In order to increase adaptivity and/or variability, a method for dynamically adjusting a wheel steering angle of at least one vehicle wheel 10, 12 of the vehicle 14, in particular by changing a toe of the vehicle wheel 10, 12, is proposed in the following. In the present case, the method is described by way of example in relation to the vehicle wheel 10 and the wheel steering angle controller 18 associated with the vehicle wheel 10, wherein the following description can, however, also be adopted for the further vehicle wheel 12 and the further wheel steering angle controller 20 associated with the further vehicle wheel 12. In the present case, the computing unit 36 is provided to perform the method and comprises for this purpose a computer program having corresponding program code means.

According to the invention, an adjustment value dependent on the driving situation, in particular in the form of an additional value, is determined as a function of a target value for the toe of the vehicle wheel 10 and a mechanical toe change correlated with a current driving situation. The target value and the mechanical toe change can be determined in advance, for example, calculated, measured or retrieved from the operating memory of the computing unit 36 or from another operating memory of the vehicle 14. In principle, however, it is also conceivable to dispense with a separate determination of a target value and/or a mechanical toe change. Furthermore, the mechanical toe change can result, for example, from a change in a vehicle height, in particular by changing a spring compression travel at the vehicle wheel 10, and/or an external force acting on the vehicle wheel 10 and/or the wheel steering angle controller 18. The adjustment value is then used to control the wheel steering angle controller 18, wherein the wheel steering angle controller 18 for dynamically adjusting the toe of the vehicle wheel 10 is actuated using the adjustment value such that the toe of the vehicle wheel 10 is set to the target value. In the present case, the method is also used to adjust the toe-in of the vehicle wheel 10. In principle, however, the method can also be used to adjust the toe-out on the vehicle wheel 10.

In this case, the mechanical toe change is set or corrected to the correct target value by a software function if there is a deviation between the target value and the mechanical toe change for the respective driving situation. The aim is to adjust an additional value for each individual wheel based on a given mechanical axle design, depending on the driving situation. This means that, in particular, toe change specifications and/or toe change requests can be fulfilled independently of the mechanical design of the vehicle 14 or the chassis.

In the present case, the target value can also be determined as a function of a steering input and preferably as a function of several sensor variables of the vehicle sensor system 22. The steering input can be applied, for example, by a driver to the steering handle 40, whereby the driver can specify a general steering input. In a further step, a desired Ackermann condition can be set. The resulting target value for the vehicle wheel 10 or for the vehicle wheels 10, 12 is in this case purely controlled and without mechanical or electronic or software adaptation to the respective driving situation. In principle, a sensor model can also be used to determine the target value in this context.

The mechanical toe change can be determined as a function of several sensor variables of the vehicle sensor system 22 and preferably of the steering input and is specific to the respective current driving situation. In the present case, sensor variables of the vehicle dynamics sensor 24, at least one of the suspension travel sensors 26, 27 and/or at least one of the force sensors 28, 30 can be used in particular. In this way, a further optimization of the adjustment value can be achieved, for example, on the basis of an image of mechanical properties, in particular on the basis of a spring deflection, and/or on the basis of a driving dynamics of the vehicle 14. In principle, a sensor model can also be used in the present case to determine the mechanical toe change.

Depending on the driving situation, it may also be useful to determine a separate, individual adjustment value for each of the vehicle's wheels 10, 12 and to set it using the respective wheel steering angle controller 18, 20. This also makes it possible to advantageously detect individual events, such as a vehicle driving over an obstacle on one side, and to take these into account when dynamically adjusting the respective toe.

The method presented here can therefore be used in principle for the dynamic adjustment of a wheel steering angle of a single vehicle wheel 10, 12 of the vehicle 14, in particular by changing a toe of the vehicle wheel 10, 12, and/or for dynamically adjusting the steering angle of a plurality of vehicle wheels 10, 12 of the vehicle 14, in particular by changing a respective toe of the vehicle wheels 10, 12.

One of the first applications of the aforementioned process is, for example, when the vehicle is compressed 14. In this case, for example, the toe change when compressed by 5 mm on the left and right should be 1°. However, due to the chassis, there is only a mechanical toe change of 0.5° in each case, so that in this case the wheel steering angle controllers 18, 20 for dynamic adjustment of the respective toe of the vehicle wheels 10, 12 are actuated using the respective adjustment value such that a further 0.5° is added in each case.

A second application of the aforementioned method may arise, for example, when the vehicle 14 is braking. In this case, the toe change when braking at 0.8 g should be 1.75° to the left and right. However, due to the chassis, there is only a mechanical toe change of 1° in each case, so that in this case the wheel steering angle controllers 18, 20 for dynamic adjustment of the respective toe of the vehicle wheels 10, 12 are actuated using the respective adjustment value such that a further 0.75° is added in each case.

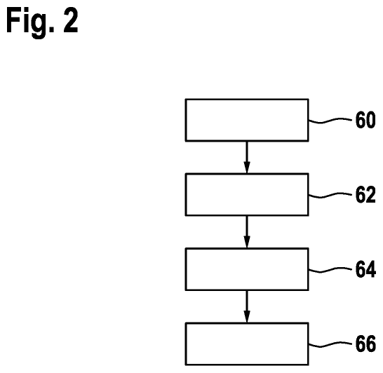

FIG. 2 finally shows an exemplary flow diagram with main process steps of the method for dynamically adjusting a wheel steering angle of at least one vehicle wheel of the vehicle 14.

In a process step 60, a current driving situation and a need for dynamic adjustment of a wheel steering angle of at least one vehicle wheel 10, 12 of the vehicle 14, in particular by changing a toe of the vehicle wheel 10, 12, are determined. For this purpose, the computing unit 36 can, for example, be designed to determine and evaluate at least one sensor variable of the vehicle sensor system 22.

In a subsequent method step 62, a target value for the toe of the at least one vehicle wheel 10, 12 and/or a mechanical toe change, correlated with the current driving situation, of the at least one vehicle wheel 10, 12 can be determined.

In a subsequent method step 64, an adjustment value dependent on the driving situation is then determined in dependence on the target value and the mechanical toe change, in particular in the form of an additional value.

In a method step 66, at least one of the wheel steering angle controllers 18, 20 for dynamically adjusting the toe of the at least one vehicle wheel 10, 12 is actuated using the adjustment value such that the toe of the vehicle wheel 10, 12 is set to the target value and a wheel steering angle of the at least one vehicle wheel 10, 12 is varied. This allows the mechanical toe change to be set or corrected to the correct target value by a software function if there is a deviation between the target value and the mechanical toe change for the respective driving situation.

The exemplary flow diagram in FIG. 2 is intended only to describe an example of a method for dynamically adjusting a wheel steering angle of at least one vehicle wheel of the vehicle 14. In particular, individual method steps can also vary, or additional method steps can be added. In this context, for example, it is conceivable to dispense with a separate determination of a target value and/or a mechanical toe change and consequently method step 62. In addition, the method can be used for dynamically adjusting the wheel steering angle of a single vehicle wheel 10, 12 on the vehicle 14 and/or for dynamically adjusting the wheel steering angle of multiple wheels 10, 12 on the vehicle 14.

1. A method for dynamically adjusting a wheel steering angle of at least one vehicle wheel of a vehicle, which has (i) a steering system with at least one wheel steering angle controller configured to change the wheel steering angle of the at least one vehicle wheel and (ii) a vehicle sensor system configured to detect a driving situation, the method comprising:
dynamically adjusting a toe of the vehicle wheel to a current driving situation in order to adapt the wheel steering angle by:
determining an adjustment value dependent on the driving situation as a function of a target value for the toe of the vehicle wheel and a mechanical toe change of the vehicle wheel correlated with the current driving situation; and
actuating the wheel steering angle controller for dynamically adjusting the toe of the vehicle wheel using the adjustment value such that the toe of the vehicle wheel is set to the target value.

2. The method according to claim 1, wherein the mechanical toe change results from a change in a vehicle height.

3. The method according to claim 1, wherein the determining of the adjustment value includes determining at least one of the target value and the mechanical toe change as a function of a steering input and as a function of at least one sensor variable of the vehicle sensor system.

4. The method according to claim 3, wherein the determining of the at least one of the target value and the mechanical toe change includes using a sensor model to determine the at least one of the target value and the mechanical toe change.

5. The method according to claim 1, wherein the vehicle sensor system includes at least one driving dynamics sensor, at least one suspension travel sensor, and/or at least one force sensor.

6. Method according to claim 1, wherein the steering system is designed as a steer-by-wire steering system and the wheel steering angle controller is designed as a single-wheel controller.

7. The method according to claim 6, wherein:
the steering system comprises at least one further wheel steering angle controller designed as a further single-wheel controller for changing a further wheel steering angle of at least one further vehicle wheel, and
a separate adjustment value for each individual wheel is determined for each of the at least one vehicle wheel and the at least one further vehicle wheel and set using the associated one of the wheel steering angle controller and the further wheel steering angle controller.

8. A computing unit comprising:
at least one processor configured to execute operating instructions stored in at least one memory to perform the method according to claim 1.

9. A motor vehicle comprising:
at least one vehicle wheel;
a steering system comprising at least one wheel steering angle controller configured to change a wheel steering angle of the at least one vehicle wheel;
a vehicle sensor system for detecting a driving situation; and
a computing unit configured to dynamically adjust a toe of the vehicle wheel to a current driving situation in order to adapt the wheel steering angle by:
determining an adjustment value dependent on the driving situation as a function of a target value for the toe of the vehicle wheel and a mechanical toe change of the vehicle wheel correlated with the current driving situation; and
actuating the wheel steering angle controller for dynamically adjusting the toe of the vehicle wheel using the adjustment value such that the toe of the vehicle wheel is set to the target value.

10. The method according to claim 2, wherein the change in the vehicle height results from at least one of (i) a changing spring compression travel on the at least one vehicle wheel and (ii) an external force acting on the at least one vehicle wheel and/or the wheel steering angle controller.

11. The method according to claim 5, wherein the vehicle sensor system includes the at least one suspension travel sensor, which is associated with a spring-damper unit of the vehicle.

12. The method according to claim 5, wherein the vehicle sensor system includes the at least one force sensor, which is associated with the wheel steering angle controller.
